(19) United States
(12) Patent Application Publication
(10) Pub. No.: US 2012/0239762 A1
(43) Pub. Date: Sep. 20, 2012

(54) Remote Communication Systems and Methods for Appliances

(75) Inventor: Gary W. Fisher, Concord, NC (US)

(73) Assignee: ELECTROLUX HOME PRODUCTS, INC., Charlotte, NC (US)

(21) Appl. No.: 13/419,752

(22) Filed: Mar. 14, 2012

Related U.S. Application Data
(60) Provisional application No. 61/452,275, filed on Mar. 14, 2011.

(51) Int. Cl. G06F 15/173; G06F 15/177; G06F 15/16

(52) U.S. Cl. 709/206; 709/223; 709/221

(57) ABSTRACT

A user may remotely monitor and adjust kitchen and laundry appliances. The appliance may have operational components for performing operational functions of the appliance, a control system for controlling the operational components, and a communication apparatus. The control system may have a user interface for allowing a user to control operation of the appliance. The communication apparatus may be operatively associated with the control system for providing information to a network, wherein the information includes data for identifying the appliance, data indicative of operational information about the appliance, and data indicative of a destination in the network for the information. The operational information about the appliance may comprise information about an operational setting and/or an operational state of the appliance. A computer located remotely from the appliance may communicate with the appliance by way of the communication apparatus and the network.

### CROSS-REFERENCE TO RELATED APPLICATION

This application claims the benefit of U.S. Provisional Patent Application No. 61/452,275, which was filed on Mar. 14, 2011. The entire disclosure of U.S. Provisional Patent Application No. 61/452,275, which was filed on Mar. 14, 2011, is incorporated herein by reference.

### FIELD OF THE INVENTION

The present invention generally relates to kitchen and laundry appliances, and more specifically relates to remotely communicating with such appliances.

### BACKGROUND

Typically a user of a laundry or kitchen appliance has to be in relatively close proximity to the appliance in order to interact with, or otherwise monitor or receive information from, the appliance. Having to be in close proximity to the appliance may be an inconvenience.

### SUMMARY

One aspect of this disclosure is the provision of systems and methods for allowing a user to remotely monitor and/or adjust appliances by way of one or more communication networks. The user may be a consumer, a provider of appliance repair or set-up services, or anyone else that may be interested in remotely accessing an appliance. The appliances may be, but are not limited to, kitchen and laundry appliances.

In one aspect of this disclosure, a kitchen or laundry appliance may have a housing containing at least one operational component for performing one or more operational functions of the appliance, a control system at least partially contained by the housing for controlling the at least one operational component, and a communication apparatus. The control system may have a user interface for allowing a user to at least partially control operation of the appliance. The communication apparatus may be operatively associated with the control system for at least providing information to at least one network, wherein the information may include data for at least partially identifying the appliance, data indicative of operational information about the appliance, and data indicative of a destination in the at least one network for the information. The operational information about the appliance may comprise information about an operational setting of the appliance and/or information about an operational state of the appliance. For example, the appliance may include at least one sensor for providing information about the operational state to the control system. The at least one network may be, or may include, the Internet, and the data indicative of the destination may be an Internet Protocol address.

Some aspects of this disclosure may be directed to at least one computer that is located remotely from the appliance for at least providing information about the appliance. Similarly, some aspects of this disclosure may be directed to a method implemented by at least one computer that is located remotely from the appliance for at least providing information about the appliance.

In one example, the at least one remotely located computer is adapted for: receiving information about the appliance over at least one network, wherein the information comprises data for at least partially identifying the appliance and data indicative of an operational state of the appliance; and automatically providing a notification in response to determining that the data indicative of the operational state meets at least one predetermined criteria. The notification may be delivered over the at least one network. The at least one network may be, or may include, the Internet. The notification may be an e-mail notification, a text message notification or a voicemail notification.

In another example, the at least one remotely located computer is adapted for: receiving and storing information about the appliance from a first location in at least one network, wherein the information comprises data for at least partially identifying the appliance and data indicative of at least one operational aspect of the appliance; receiving a request for information from a second location in the at least one network; sending at least some of the information about the appliance to the second location in the at least one network; receiving information from the second location in the at least one network; and sending an instruction for changing an operational aspect of the appliance to the first location in response to the receiving of the information from the second location. The operational aspects may be one or more operational settings of the appliance and/or one or more operational states of the appliance. The at least one network may be, or may include, the Internet. The information about the appliance that is sent to the second location may be presented in the form of, or as part of, a web page.

The foregoing is a simplified summary for providing a basic understanding of some aspects of this disclosure. This summary is not an extensive overview and is not intended to identify key or critical elements of the invention or to delineate the scope of the invention. The purpose of this section is to present some concepts of the disclosure in a simplified form as a prelude to the more detailed description that is presented below. Other aspects of this disclosure will become apparent from the following.

### BRIEF DESCRIPTION OF THE DRAWING

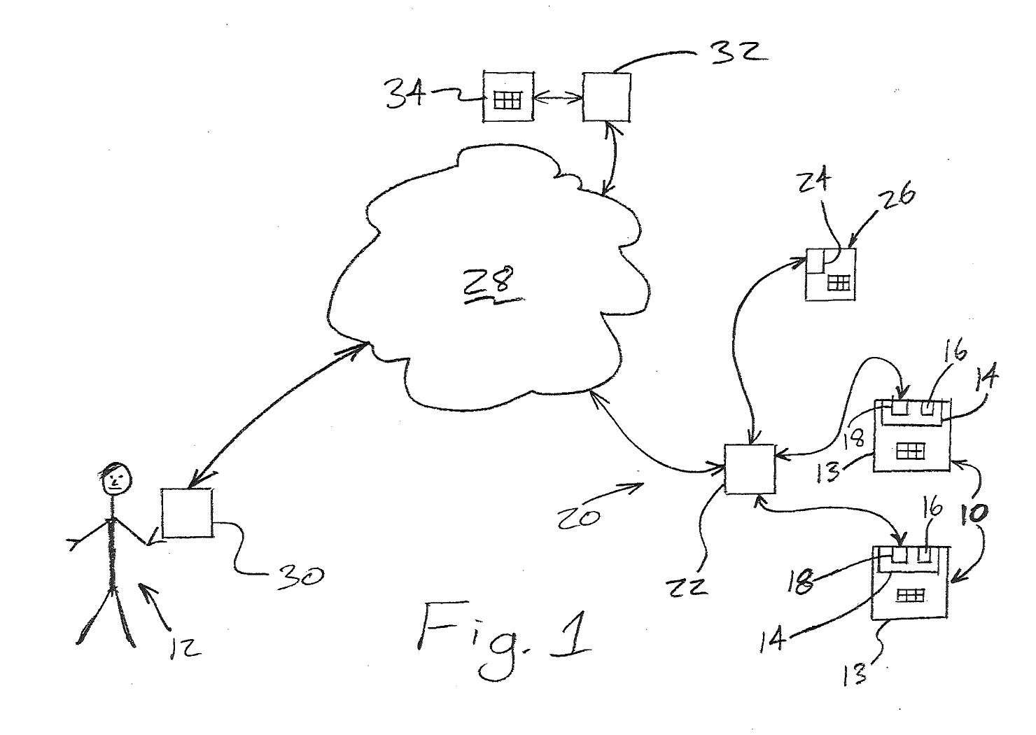

Having described some aspects of this disclosure in general terms, reference will be made in the following to the attached FIG. 1, which schematically shows a remote communication system for appliances, in accordance with a first embodiment of this disclosure.

### DETAILED DESCRIPTION

Exemplary embodiments of this disclosure are described below and illustrated in the accompanying figure, in which like numerals refer to like parts. The embodiments described provide examples and should not be interpreted as limiting the scope of the invention. Other embodiments, and modifications and improvements of the described embodiments, will occur to those skilled in the art and all such other embodiments, modifications and improvements are within the scope of the present invention.

Referring now in greater detail to the drawing, FIG. 1 schematically shows one or more appliances 10 that are at least temporarily inaccessible to a user 12 such that the user may not directly interact with, or otherwise directly monitor or receive information from, the appliances. In accordance with a first embodiment of this disclosure, the appliances 10 are kitchen and/or laundry appliances, although other types of appliances are also within the scope of this disclosure. The kitchen appliance(s) may be one or more of an oven, stove, range, warmer, toaster, dishwasher, refrigerator, freezer, and coffee maker. The laundry appliance(s) may be one or more of a laundry washer and/or a laundry dryer. Other types of appliances are also within the scope of this disclosure. In one specific example, one of the appliances 10 may be a freestanding induction range, and the other appliance may be a double wall oven.

The appliances 10 may be at least temporarily physically inaccessible to the user 12 for a variety of reasons. As one example, the user may be relatively far away from the appliances, such as by the user being several yards away from the appliances, or the user being any number of miles away from the appliances. In addition or alternatively, the appliances 10 may be at least temporarily inaccessible to the user 12 because one or more walls of a building or other obstacles may separate the user from the appliances. In accordance with the first embodiment of this disclosure, the user 12 may remotely interact with, or otherwise monitor or receive information from, the physically inaccessible appliances 10 by way of a remote communication system, as will be discussed in greater detail below. Alternatively, the user 12 may interact with, or otherwise monitor or receive information from, the appliances 10 by way of the remote communication system while the user is in very close proximity to, or otherwise has direct access to, the appliances.

Even with the provision of the remote communication system, each of the appliances 10 may optionally include features for allowing the user 12 to directly interact with, or otherwise directly monitor or receive information from, the appliance while the user is in relatively close proximity to the appliance. For example, each appliance 10 may include conventional features for allowing the user 12 to directly interact with, or otherwise directly monitor or receive information from, the appliance while the user is in relatively close proximity to the appliance. The remote communication system of the first embodiment may include or otherwise use some of the features of the appliances 10 that are for allowing the user to interact directly with the appliances. Accordingly, a discussion of the remote communication system of the first embodiment will follow a discussion of the features of the appliances 10 that are for allowing the user to directly interact with the appliances.

Each of the appliances 10 typically includes a housing 13, operational components mounted within and carried by the housing for performing the operational functions of the appliance, and a control system 14 at least partially mounted within and carried by the housing. The control system 14 is in communication with the operational components for receiving information from and/or providing information to the operational components for coordinating the operational functions of the appliance 10. The type and number of the operational components included in the appliance 10 will depend upon the functionality of the appliance. For example, the operational components of a kitchen oven, range or food warmer may include one or more heating elements for heating a chamber of the appliance that is accessible by a door, and one or more temperature sensors for measuring the temperature within the chamber. As another example, a laundry appliance (e.g., a washing or drying machine) typically includes a tub portion, supported within the housing, in which laundry may be placed for washing and/or drying. The tub portion may also define an access opening that may be located at an upper surface or a forward surface of the appliance. A door assembly may be pivotably engaged with the tub portion or housing so as to selectively permit access to the interior of the tub portion via the access opening. A washing or drying drum is rotatably disposed within the tub portion of the respective washing and drying appliance for agitating or spinning the laundry during the washing or drying process. The laundry appliance includes particular operational components (e.g., pumps, valves, motors, etc.) for performing the operational functions thereof.

The control system 14 may be embodied in any suitable manner, such as in software, firmware and/or hardware modules. For example, the control system 14 may be in the form of one or more computer or computer-like devices (which may include one or more appropriate input and output devices, processors, memories and software modules) for controlling operational components of the appliance by virtue of receiving data from and/or providing data (e.g., instructions) to respective operational components. The control system 14 may include or otherwise be associated with a user interface 16. The user interface 16 is configured for being directly interacted with by the user of the appliance 10, so that the user may initiate, terminate, and otherwise at least partially control operation of the appliance while the user is facing and can touch the user input devices of the user interface. In this regard, the user interface 16 may include one or more physical, manually-actuatable buttons and/or dials mounted to and accessible to the user 12 at a control panel of the appliance 10, and/or one or more audio devices, such as buzzers or speakers. The control panel may be located at a front or top face of the appliance 10, or in any other suitable location.

In addition or alternatively, the user interface 16 of each appliance 10 may be in the form of, or include, a touchscreen user interface. The touchscreen user interface may be associated with one or more software, firmware and/or hardware modules that are operative for causing the touchscreen user interface to display icons, and to be responsive to touches by a user, so that the user may control operation of, and access information about, the appliance 10 by way of the touchscreen user interface. A user may interact with the touchscreen user interface by way of a display screen of the touchscreen user interface. The display screen may comprise a liquid crystal display (LCD) or other display device capable of providing graphics/images to the user 12 while the user is in opposing face-to-face relation with the display screen. The touchscreen user interface may be configured to present a plurality of virtual buttons or icons on the display screen. Each icon may be configured to include graphics and/or text (i.e., a string of alphanumeric characters) to provide the user with an indicia of a position on, or area of, the display screen with which the user may interact (i.e., touch) in order to select the corresponding icon. In some instances, the icon may have the appearance on the display screen of a physical button (i.e., via three-dimensional graphics imaging), while in other instances the icon may only appear as text, a graphic, or combinations thereof on the display screen.

More specifically regarding the remote communication system of the first embodiment, wireless adapters 18 (e.g., local communication apparatus) are respectively closely associated with the appliances 10. For each of the appliances 10, the wireless adapter 18 may be an integral part of the control system 14 of the appliance, or the wireless adapter may be retrofitted to the control system. In one retrofit option, the wireless adapter 18 may be a peripheral device that is connected to a suitable interface of the control system 14. Examples of suitable interfaces may include, but are not limited to, universal serial bus (USB) ports, serial ports and parallel ports. Irrespective, the wireless adapter 18, or at least a substantial portion thereof, may be contained within the appliance's housing 13. For example, one or more antenna of the wireless adapter 18 may project from the appliance's housing 13. The wireless adapter 18 includes and/or may be more generally referred to as a local transceiver, which may be replaced with a transmitter and/or receiver, or any other suitable communication device.

Whereas the wireless adapters 18 may be characterized as being part of, or otherwise closely associated with, the respective appliances 10, at the same time the wireless adapters may also be characterized as being part of a wireless local area network 20. In accordance with the first embodiment, the local area network 20 further includes at least one wireless router 22 (e.g., an intermediate communication apparatus) for wirelessly communicating with the wireless adapters 18. The wireless router 22 is typically in sufficiently close proximity to the appliances 10 for being in good wireless communication with the wireless adapters 18. The wireless router 22 includes and/or may be more generally referred to as an intermediate transceiver, which may be replaced with a transmitter and/or receiver, or any other suitable communication device.

Whereas only a single local area network 20 and two appliances 10 are shown in FIG. 1, the remote communication system of the first embodiment may include numerous of the local area networks 20/numerous of the appliances 10. Each of the local area networks 20 may optionally include other suitable devices, such as a wireless adapter 24 of a local computer 26. In one example, the local computer 26 may be operative for providing a web site and/or operative for providing or otherwise initiating notifications. The web site may have at least one web page for at least providing information about the appliances 10, and the notifications may provide information about the appliances, as will be discussed in greater detail below.

For each of the local area networks 20, the wireless router 22 is in communication with a network 28 that forms part of the remote communication system of the first embodiment. The network 28 may optionally be referred to as an overarching network 28. The overarching network 28 may include one or more suitable communication networks, such as, but not limited to, the Internet, cable television networks, cellular data networks, and/or the public switched telephone network. In accordance with the first embodiment, the overarching network 28 comprises the Internet, and a suitable connection between the wireless router 22 and the Internet may be at least partially provided by a cable modem, Digital Subscriber Line modem, by one or more cellular data networks, or by any other suitable device(s). In one specific example, the wireless router 22 is operative so that the local area network 20 is a Wi-Fi wireless local area network, and the router 22 and wireless adapters 18, 24 may operate in accordance with the ZigBee standard. However, any suitable router 22 and adapters 18, 24 may be used, and the local area network may be in any other suitable form, such as by not being wireless (e.g., it may be a wired network, a fiber optic network, and/or any other suitable network).

The remote communication system of the first embodiment may include numerous conventional remote communication apparatuses 30 that are for being in communication with the overarching network 28. In accordance with the first embodiment, each remote communication apparatus 30 includes a user interface and processor in combination with one or more of a web browser, a wireless adapter for communicating with a local area network that provides a connection to the Internet, a transceiver for communicating with one or more cellular data networks (e.g., to access the Internet) and/or a notification manager for managing emails, text messages and/or voicemails. For example, the remote communication apparatus 30 may be a computer adapted for communicating with the Internet and/or a device with cellular telephone capabilities that may optionally also be adapted for communicating with the Internet (e.g., a cellular telephone, a cellular-enabled personal digital assistant, or the like).

The remote communication system of the first embodiment may include any number of other suitable devices, such as at least one router 32 connected between the overarching network 28 and at least one remote computer 34. The remote computer 34 may be operative for providing a web site having at least one web page and/or operative for providing or otherwise initiating notifications, as will be discussed in greater detail below. The remote computer 34 shown in FIG. 1 may be representative of a series of servers for providing services with respect to numerous of the local area network 20, appliances 10 and remote communication apparatuses 30. Accordingly, a series of servers may be referred to as a single server, and vice versa, in this detailed description section of this disclosure.

An example of some aspects associated with operating a representative one of the appliances 10 will be described in the following, in accordance with the first embodiment of this disclosure. A user 12 may interact with the user interface 16 of the representative appliance 10 to change operational settings so that the controller of the representative appliance's control system 14 follows an instruction or a set of instructions for causing the representative appliance to carry out an operation or a series of operations. For example, the user may operate the user interface 16 of the respective appliance 10 to adjust settings that define, or at least partially define, the instructions that the control system 14 follows for causing the appliance to carry out an operation or a series of operations. In addition to following the instruction or instructions, the controller of the control system 14 typically monitors operational information about (e.g., the operational states of) the representative appliance 10.

In accordance with the first embodiment, the controller of the control system 14 (or the controller in combination with another suitable computer or computer-like device) is operative, by way of appropriate software, firmware and/or hardware modules, for providing data about such instruction(s) and/or state(s), along with other suitable data, such as data at least partially identifying the representative appliance (e.g., an Internet Protocol address assigned to the representative appliance) and the destination for this data (e.g., another Internet Protocol address that identifies the destination for the data), to the wireless adapter 18 for transmission. The wireless router 22 receives the data transmitted from the wireless adapter 18 and transmits the data in the appropriate format to the appropriate location.

In accordance with the first embodiment, the data transmitted by the wireless router 22 may be received by the local computer 26 (by way of the local area network 20 and wireless adapter 24) and/or the remote computer 34 (by way of the overarching network 28 and router 32). In this regard, one or the other of the computers 26, 34 may be omitted, and one or more of the computers 26, 34 functions as a server for providing or otherwise initiating notifications and/or for providing one or more web sites having one or more web pages. As mentioned above and as will be discussed in greater detail below, the web pages are for at least providing information about the appliances 10, and the notifications may provide information about the appliances.

Examples of how a representative server (e.g., one or more of the computers 26, 34) may handle the data originating from a representative one of the appliances 10 is described in the following, in accordance with the first embodiment. The server is operative in and of itself, or in conjunction with one or more other servers, for providing or otherwise initiating notifications and/or for providing one or more web sites having one or more web pages for at least providing information about or otherwise related to the data received from the representative appliance 10.

The server (e.g., one or more of the computers 26, 34) receives information about the representative appliance 10 by way of the respective portions of the networks 20, 28. The received information includes data for at least partially identifying the representative appliance 10 and data indicative of at least one operational state of the representative appliance. In accordance with one aspect of this disclosure, the server determines whether the data indicative of at least one operational state meets at least one predetermined criteria for the representative appliance 10. The server automatically initiates a providing of a notification, which is for being delivered over at least the overarching network 28, in response to the server determining that the data indicative of at least one operational state meets predetermined criteria. This determination by the server may be made by the server utilizing at least one lookup table, or the like, that is stored in a database and includes information about the predetermined criteria for the representative appliance and a destination in the network for the notification. The notification may be an e-mail notification, a text message notification, a voicemail notification and/or any other suitable notification that may be directed to the respective remote communication apparatus 30.

As alluded to above, the server may be serving numerous of the local area networks 20, appliances 10 and remote communication devices 30, and the lookup table, or the like, may be populated with information regarding the details of how this servicing by the server is to be carried out. Accordingly, the server may utilize the lookup table, or the like, to store, organize, and respectively select from numerous entries regarding predetermined criteria for the appliances 10 and destinations for the notifications and other communications that may be originated by the server. In the lookup table, or the like, each appliance 10 may have associated therewith one or more different, tailored predetermined criteria, notifications, and destinations in the networks for the notifications. Accordingly, the lookup table, or the like, may be a mechanism for organizing all of this information and searching through it. Alternatively, any other suitable mechanisms and/or techniques may be used for organizing all of this information and searching through it.

As one specific example, when the representative appliance 10 is an oven, the server may send a notification to the respective remote communication apparatus 30 in response to the oven reaching a preheat temperature, and the notification may be one or more of a text or voice message, or an email, indicating that the preheat temperature for the oven has been reached. The user may similarly automatically receive notifications from the server at the end of a cook time for the representative appliance 10, when a delayed start operation of the representative appliance occurs, or when a cleaning operation of the representative appliance is terminated. The user may similarly automatically receive notifications on a temporal (e.g., hourly) basis indicating how much cooking time or how much of a cleaning operation remains for the representative appliance 10.

In accordance with one aspect, the server may be operative to use the information that it has received about the appliances 10 via the respective portions of the networks 20, 28 to populate a web site or at least one web page for each of the appliances. More specifically, the server may store the received information in any suitable location and form, such as in a database and in the form of a lookup table, or the like. The web pages may be respectively populated in response to the web pages being respectively requested by the remote communication devices 30.

In accordance with one aspect of this disclosure, the server provides a variety of differently configured web sites and web pages because, in one example, each of the web sites or pages may be customized to the desires of a respective user 12 and/or adapted to the peculiarities of the respective appliance 10. Alternatively, the web sites or pages provided by the server may be more standardized or substantially standardized, so that substantially the same web site or web page is used for multiple of the appliances 10, except that the data and any options presented by the web page would be customized for the respective appliance, as may be determined by the server using the above-discussed lookup table, or the server using any other suitable mechanisms and/or techniques for tailoring to the respective user and/or appliance.

Further regarding the representative server and the representative appliance 10, the server receives information about the representative appliance 10 by way of the respective portions of the networks 20, 28, and the server stores the information it receives in a database. The received information includes data for at least partially identifying the representative appliance 10 and data indicative of at least an operational state of the representative appliance. The server receives a request for information about the representative appliance 10 from the respective remote communication apparatus 30. In response to that request, the server provides a web site or at least a web page to the respective remote communication apparatus 30, with the web page including information about the representative appliance 10.

As alluded to above, the web site or web page provided to the remote communication apparatus 30 may take on a variety of different forms. In one example, the web site or web page provides all of, or at least substantially all of, the information (e.g., operational states) and options (e.g., operational settings) to the user 12 that the user would have access to if the user were able to directly interact with the user interface 16 of the representative appliance. That is and in accordance with one aspect of this disclosure, the representative appliance 10 may have sufficient capabilities and the respective web page or web site provided by the server may have sufficient capabilities so that the server may send to the representative appliance an instruction for changing an operational state of the representative appliance in response to the server receiving appropriate instructions from the respective remote communication apparatus 30 by way of the representative web page or web site. Suitable password protection and/or other precautions may be incorporated to restrict unwanted access to the web sites or pages.

In another example, the web site or web page provides only a subset of all of the information and options that the user would have accessible if the user were able to directly interact with the user interface 16 of the representative appliance. For example and in accordance with one aspect of this disclosure, provisions can be made such that the user may not perform by way of their remote communication apparatus 30 all of the options that the user would be able to perform if the user were able to directly, manually interact with the user interface 16 of the representative appliance. As one specific example, the web site or web page may be set up such that the user 12 may not turn on a cooking appliance by way of the remote communication apparatus 30, due to potential dangers associated with remotely operating a cooking appliance. On the other hand and as other examples, the web site or web page may be set up such that the user 12 may turn off, turn down the temperature of, or make other adjustments to the operation of a cooking appliance by way of the remote communication apparatus 30.

As one specific example, when the representative appliance 10 is an oven and the oven is started (e.g., turned on or otherwise has its control system 14 programmed with a time to be turned on), the server automatically makes available an updated web page for the oven, so that the web page is available to display the current operational setting(s) for and/or operational state(s) of the oven (e.g., bake, broil, etc.), the temperature set for the oven, the time of day, current temperature in the oven, which heating elements of the oven are active, the cook time remaining for the oven, any delay start time for the oven, any time remaining until the oven starts, any preheat status of the oven, and any other desired and/or available information and/or options for the oven. For example, other options or information that may be available may relate to an AirGuard brand feature for keeping any unpleasant odors in the oven, or any other relevant features.

In one aspect of the first embodiment of this disclosure, the user 12 may be considered to be a person using the appliances 10 for the appliances' intended purposes. However, numerous variations are within the scope of this disclosure. For example, other embodiments of this disclosure may be like the first embodiment of this disclosure, except for variations noted and variations that will be apparent to one of ordinary skill in the art.

In accordance with one aspect of the first embodiment and/or in accordance with another embodiment of this disclosure, one of the users 12 may be a person providing appliance repair or set-up services, or any other suitable services, and this service provider may use a remote communication apparatus 30 to interact with, or otherwise monitor or receive information from, an appliance 10 by way of the remote communication system of this disclosure. The capabilities of the web sites or web pages provided by the server(s) 34 may be tailored to the needs or desires of the person providing the services.

In accordance with one aspect of the first embodiment and/or in accordance with another embodiment of this disclosure, cloud computing services may be incorporated into the remote communication system of this disclosure. For example, one or more of the operabilities provided by the remote computer 34 and/or the overarching network 28 may be provided by way of cloud computing services. As other examples, numerous other features may be incorporated into or substituted for respective features of the remote communication system of this disclosure. For example, a variety of electronic commerce features may be incorporated into or otherwise associated with the remote communication apparatus of this disclosure.

Although the above disclosure has been presented in the context of exemplary embodiments, it is to be understood that modifications and variations may be utilized without departing from the spirit and scope of the invention, as those skilled in the art will readily understand. Such modifications and variations are considered to be within the purview and scope of the appended claims and their equivalents.

What is claimed is:

1. A kitchen or laundry appliance, comprising:
a housing containing at least one operational component for performing at least one operational function of the appliance;
a control system at least partially contained by the housing for controlling the at least one operational component, the control system comprising a user interface for allowing a user to at least partially control operation of the appliance; and
a communication apparatus operatively associated with the control system for at least providing information to at least one network, wherein the information includes data for at least partially identifying the appliance, data indicative of operational information about the appliance, and data indicative of a destination in the at least one network for the information.

2. The kitchen or laundry appliance according to claim 1, wherein:
the at least one network comprises the Internet; and
the data indicative of the destination in the at least one network comprises an Internet Protocol address.

3. The kitchen or laundry appliance according to claim 1, wherein the data indicative of operational information about the appliance comprises data indicative of an operational state of the appliance.

4. An apparatus for at least providing information about a kitchen or laundry appliance, the apparatus comprising:
at least one computer that is located remotely from the appliance and is adapted for
receiving, over at least one network, information about the appliance, the information comprising data for at least partially identifying the appliance and data indicative of an operational state of the appliance;
determining whether the data indicative of the operational state meets at least one predetermined criteria for the appliance; and
automatically initiating a providing of a notification, configured to be delivered over the at least one network, in response to determining that the data indicative of the operational state meets that at least one predetermined criteria.

5. The apparatus according to claim 4, wherein the at least one network comprises the Internet.

6. The apparatus according to claim 4, wherein the notification comprises at least one notification selected from the group consisting of an e-mail notification, a text message notification and a voicemail notification.

7. The apparatus according to claim 4, comprising a database including information about:
the at least one predetermined criteria for the appliance, and
a destination in the at least one network for the notification.

8. An apparatus for at least providing information about a kitchen or laundry appliance, the apparatus comprising:
at least one computer located remotely from the appliance and adapted for receiving and storing information about the appliance from a first location in at least one network, the information comprising data for at least partially identifying the appliance and data indicative of at least one operational aspect of the appliance;
receiving a request for information from a second location in the at least one network;
sending at least some of the information about the appliance to the second location in the at least one network in a predetermined format;
receiving information from the second location in the at least one network; and
sending an instruction for changing an operational aspect of the appliance to the first location in response to the receiving the information from the second location in the at least one network.

9. The apparatus according to claim 8, wherein the instruction for changing an operational aspect of the appliance comprises an instruction for changing an operational setting of the appliance.

10. The apparatus according to claim 8, wherein the data indicative of at least one operational aspect of the appliance comprises data indicative of at least one of an operational state and an operational setting of the appliance.

11. The apparatus according to claim 8, wherein:
the at least one network comprises the Internet; and
the sending the at least some of the information about the appliance to the second location in the at least one network in the predetermined format comprises sending the at least some of the information about the appliance to the second location as a web page.

12. A method for at least providing information about a kitchen or laundry appliance, the method being implemented by at least one computer located remotely from the appliance, and the method comprising:
receiving, over at least one network, information about the appliance, the information comprising data for at least partially identifying the appliance and data indicative of an operational state of the appliance;
determining whether the data indicative of the operational state meets at least one predetermined criteria for the appliance; and
automatically initiating a providing of a notification, configured to be delivered over the at least one network, in response to determining that the data indicative of the operational state meets that at least one predetermined criteria.

13. The method according to claim 12, wherein the method comprises providing a web site by way of the at least one computer, and at least one of the steps of receiving, determining and automatically initiating is facilitated by way of the website.

14. The method according to claim 12, wherein the at least one network comprises the Internet.

15. The method according to claim 12, wherein the notification comprises at least one notification selected from the group consisting of an e-mail notification, a text message notification and a voicemail notification.

16. The method according to claim 12, wherein determining whether the data indicative of the operational state meets the at least one predetermined criteria for the appliance comprises querying a database including information about the at least one predetermined criteria for the appliance, and wherein the database comprises an association between the at least one predetermined criteria and the appliance.

17. The method according to claim 12, wherein automatically initiating the providing of the notification comprises querying a database including information about a destination in the at least one network for the notification, and wherein the database comprises an association between the designation and the appliance.

18. A method for at least providing information about a kitchen or laundry appliance, the method being implemented by at least one computer located remotely from the appliance, and the method comprising:
receiving and storing information about the appliance from a first location in at least one network, the information comprising data for at least partially identifying the appliance and data indicative of an operational aspect of the appliance;
receiving a request for information from a second location in the at least one network;
sending at least some of the information about the appliance to the second location in the at least one network in a predetermined format;
receiving information from the second location in the at least one network; and
sending an instruction for changing an operational aspect of the appliance to the first location in response to the receiving the information from the second location in the at least one network.

19. The method according to claim 18, wherein the instruction for changing an operational aspect of the appliance comprises an instruction for changing an operational setting of the appliance.

20. The method according to claim 18, wherein the data indicative of at least one operational aspect of the appliance comprises data indicative of at least one an operational state and an operational setting of the appliance.

21. The method according to claim 18, wherein the method comprises providing a web site by way of the at least one computer, and the steps of sending the at least some of the information about the appliance to the second location, and receiving the information from the second location are facilitated by way of the website.

22. The method according to claim 18, wherein:
the at least one network comprises the Internet; and
sending the at least some of the information about the appliance to the second location in the at least one network in the predetermined format comprises sending the at least some of the information about the appliance to the second location as a web page.
